(19) United States
(12) Patent Application Publication
(10) Pub. No.: US 2012/0282570 A1
(43) Pub. Date: Nov. 8, 2012

(54) Toothcleaning Device

(76) Inventor: Daniel Mueller, Burgstall (IT)

(21) Appl. No.: 13/514,656

(22) PCT Filed: Dec. 8, 2009
(86) PCT No.: PCT/IB2009/007724

§ 371 Date: Jul. 5, 2012

(51) Int. Cl. A61C 17/02

(52) U.S. Cl. 433/88

(57) ABSTRACT

Equipment for daily dental care: teeth are cleaned by water jet with admixed softly abrasive media for the dissolution of plaques. A particular mixing chamber for the transfer of the ingredients from tabs may be branched either to by passes on faucets or showering mixing taps or to hereditary water jet pumping systems. Pressure and spray characteristics of the jet can be adjusted with a spiral nozzle.

### FIELD OF THE INVENTION

The here disclosed invention refers to a tooth cleaning device and more particularly to a water jet system that removes plaques by adding soft abrasive media (besides other dental care ingredients) to the water from tabs in a mixing chamber and by transforming the jet into a particular concentric spray.

### BACKGROUND OF THE INVENTION

Tooth cleaning as a daily ritual is well known to often be neglected or carried out but ineffectively, due to shortage of time.

Stressed people in particular tend to brush too firmly, thus deteriorating the covers of the neck of teeth and tend to stop and rinse before a real cleaning effect could be in effect.

However, there is but little sense in firmly prescribing application times, since failing to comply with it does not result in immediately observable effects.

### PRIOR ART

There had been quite a few attempts to enhance tooth cleaning, as e.g. electrically driven toothbrushes and water jet cleaners. However, these both fail to improve dental care.

The first one does only avoid the need to move a toothbrush, but otherwise shows similar drawbacks when applied with too much pressure.

The latter may rinse off foodstuff residues, but does not effectively contribute to wiping off beginning plaques, although U.S. Pat. No. 6,056,710 and U.S. Pat. No. 6,475,173 claim to do so. This is because a therefore necessary pressure of a water jet would be irreconcilable in a sensitive area like the human oral cavity.

Another proposition, as in WO2002/054971 was the admix of ozone blisters to a water jet. Besides detrimental effects of ozone on mucous membrane it seems quite questionable, whether imploding blisters might not result in cavitational pitting of the dental enamel, instead of only cleaning it.

Other additives, in particular disinfectants, as proposed in EP 0 322 223 and WO 96/27344 might show positive effects in tooth cleaning, however their impact to patient's health, particularly when swallowed, seems critical. This might be the reason, why non such applications have taken hold.

### DESCRIPTION OF THE INVENTION

An apparatus to provide effective tooth cleaning, comprising the dissolution of plaques is disclosed, wherein mildly abrasive ingredients are dispersed in a water jet. The system comprises a mixing chamber, wherein tabs of different compositions are dispersed. The particular dissolution process determines the application time, which therefore is naturally ascertained.

The cleaning effect is achieved with a water jet of 10 to 15 bar, which might be branched off through a bypass of a faucet or showering mixing tap (which usually offer 5 to 8 bar) when reducing the diameter of the outlet, whereas the pressure is regulated with an automatically adjusting ring nozzle. Otherwise adequate pressure can be realized with a electrical pumping system as known from conventional water jet oral cleaners.

Complementary, the ring nozzle does provide adequate spray distribution, so to ensure a good cleaning effect without risk of hurting the gingivae.

Said water jet as such would not sufficiently clean teeth and particularly not remove plaques. Therefore additives of mildly abrasive character, such as silicious earth (SiO2) calcium carbonates or magnesium carbonates with a grading of 0.6 up to 1.5 microns are applied, which have proved to be particularly effective in removing plaques at medium or long-term application and which are harmless, even when swallowed.

Other possible ingredients, like sodium fluoride for strengthening the dental enamel, tensides for easier dissolution of the tablet, sodium hydrogen carbonates for adjusting the pH-value and other, like flavoring agents, might as well be added.

In another embodiment, these tabs may consist of an assembly of skins with different composition or level of compaction, so as to provide alternating cleaning phases with different ingredients, or concentrations of additives due to varying dissolution times.

In order for these additives to be consistently discharged into the water jet, a mixing chamber is provided, that holds and constantly dissolves tabs of different compositions.

Meeting these demands requires uniform circulation of the water flow around the tabs, which is achieved with a design matching the tablet form, adequate braces and a hydro-dynamically shaped dissolution chamber.

Uniform flow is particularly important to ensure the constant and complete dissolution of the tab, instead of leaving residues, that otherwise would have to be cleaned off manually.

It has been found, that flat tablets of approximately 10 mm diameter comply best with an oval shape of 7 mm and 4 mm radii, comprising a filter grid of each 0.3 mm mesh on the inlet and outlet, whereas other combinations might as well prove to be suitable.

The targeted dissolution of these tablets also provide the requested timing of dental cleaning.

Unlike with coding of electric toothbrushes, which may only remind of complying with predetermined sequences of dental care, it is mandatory here due to the fact, that otherwise the rest of the tablet has to be removed and the dissolution chamber to be cleaned manually.

However, overexposing is not only well to be realized, because of the sudden swelling of the water stream, but also harmless, since no more abrasive ingredients are entered.

The ring nozzle can be operated manually to provide an adequate water jet stream, loaded with the above mentioned ingredients.

However, when used along with water tap bypasses, it is preferred to automatically regulate the water pressure at the input of the mixing chamber, since pressure of water supply might widely vary due to location and circumstances—it even often varies over different floors of a building, or due to different plumbing.

Along with a more sophisticated embodiment of the here disclosed invention, this is balanced with the application of an automatically self-regulating nozzle, consisting of a widely threaded injector, that is spring-based within a slightly conical duct of a little greater diameter. With rising water input pressure the systems is reducing the bypass diameter and thus the water pressure on the outgoing side. Adequate systems are well known in the art and some even available off the shelf.

### DESCRIPTION OF THE DRAWINGS

For further explanation of the system, the following drawings are meant to exemplify the system as follows:

FIG. 1 shows the general setup, wherein the output of the bypass of a tap (not shown) is led by a flexible tube or hose 2 to the mixing chamber 3, containing the tablet 4. The output 5 of said chamber leads through another tube or hose 6 to the nozzle 7, which is directed to the surface of the teeth (not shown).

FIG. 2 demonstrates the water flow within the mixing chamber 3, wherein the input water stream 10 is directed around the tablet 11, which is held within the filter grid 12, while the water stream is divided and torrented in secondary swirls 14 to 17, so to equally ablate the tablet 11 from all sides.

FIG. 3 explains the function of the automatic ring nozzle, wherein the output of the mixing chamber (see FIG. 2) is the input 20 to the throat 21 of the nozzle, pressurizing the threaded injector 13 which can move in axial direction within the slightly bigger start-diameter 22 of the conical duct 23 against the counterpressure of the spiral spring 24, the compression of which is to be adjusted by turning the corrugated cap nut 25 on the injector body 26.

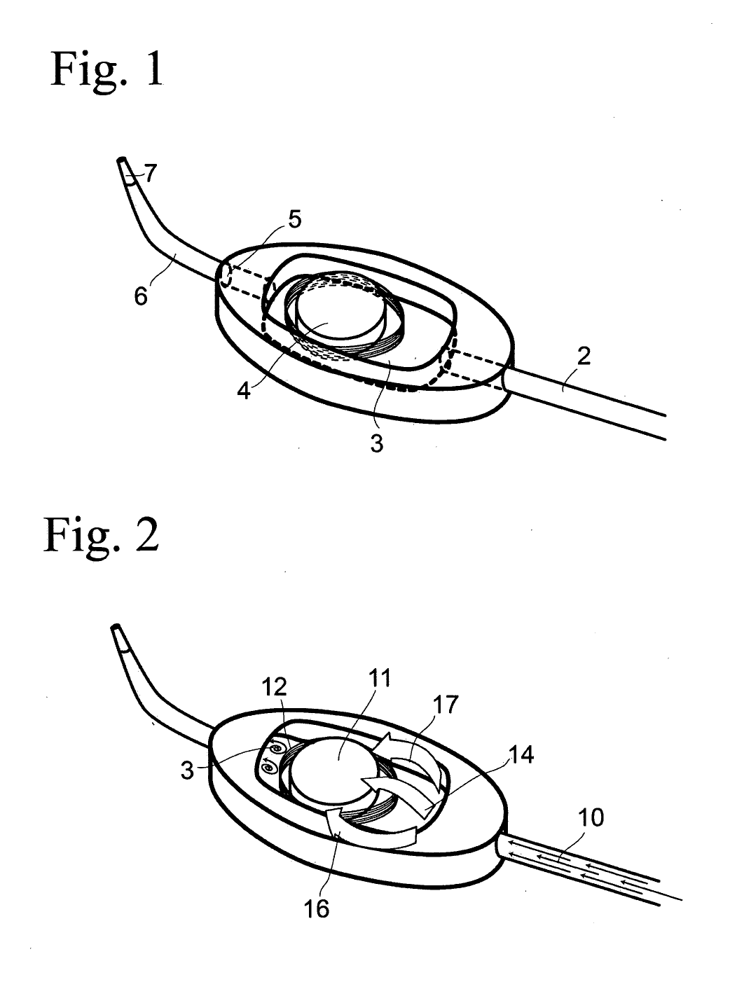

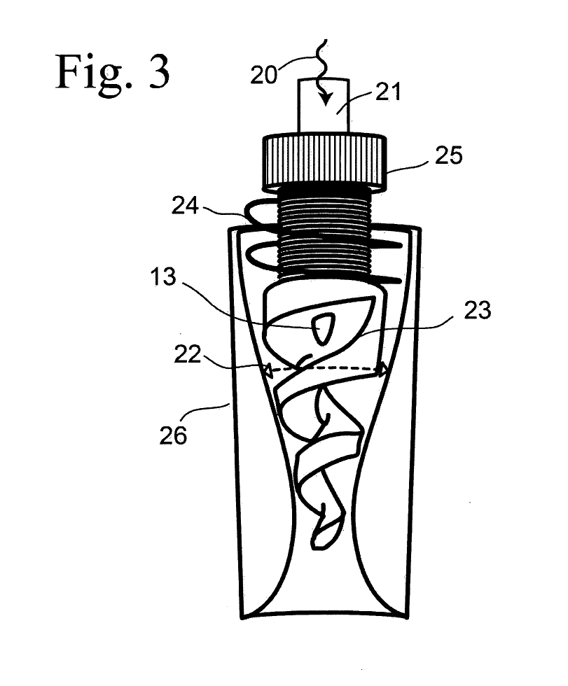

1. A tooth cleaning device, comprising a water jet spray system fed through a mixing chamber with additives, wherein the additives contain mildly abrasive ingredients for the dissolution of plaques.

2.-16. (canceled)
